(19) United States
(12) Patent Application Publication
(10) Pub. No.: US 2011/0281076 A1
(43) Pub. Date: Nov. 17, 2011

(54) Natural Fiber Trim Panel

(75) Inventors: Beau Anderson, Grandville, MI (US); Jeffrey T. Stout, Grand Rapids, MI (US); Craig D. Flowerday, Holland, MI (US); Tony Pokorzynski, Holland, MI (US); Jennifer Stroebe, Holland, MI (US); Sreenivas Paruchuri, Duesseldorf (DE); Holger Kalus, Duisburg (DE)

(73) Assignee: JOHNSON CONTROLS TECHNOLOGY COMPANY, Holland, MI (US)

(21) Appl. No.: 13/143,549

(22) PCT Filed: Jan. 8, 2010
(86) PCT No.: PCT/US10/20454

§ 371 Date: Jul. 24, 2011

Related U.S. Application Data
(60) Provisional application No. 61/143,619, filed on Jan. 9, 2009.
(60) Provisional application No. 61/239,563, filed on Sep. 3, 2009.

(51) Int. Cl. B32B 3/06; B32B 5/00; B32B 38/08; B32B 37/06; B32B 38/00; B32B 5/02; B32B 3/30

(52) U.S. Cl. 428/165; 428/221; 428/332; 428/306.6; 156/308.2; 156/222; 156/196

(57) ABSTRACT

A trim panel formed from natural fibers and a protective material, and a method of forming the trim panel. The natural fibers are environmentally-friendly and the protective material may be sufficiently adhered to the natural fibers without the use of hot melts or adhesives. The protective material is configured to be permeable to gasses and water vapor during application and once applied impermeable to UV light and liquids such as water and soda.

### CROSS REFERENCE TO RELATED APPLICATIONS

This application claims priority to International Application No. PCT/US2010/020454 filed on Jan. 8, 2010, entitled “Natural Fiber Trim Panel,” U.S. Provisional Application Ser. No. 61/143,619 filed on Jan. 9, 2009, entitled “Exposed Natural Trim Fiber” and U.S. Provisional Application Ser. No. 61/239,563 filed on Sep. 3, 2009, entitled “Natural Fiber Trim Panel,” the entire disclosures of all of these applications being considered part of the disclosure of this application and hereby incorporated by reference.

### BACKGROUND

1. Field of the Invention

This invention relates to an automobile trim panel and in particular, environmentally-friendly trim panels which are formed from natural fibers where the natural fiber layer is exposed to view, and includes an applied protective film, to prevent stains and other negative effects from various environmental factors.

2. Related Art

The use of multi-layer or laminate panels in automobile trim panels such as, for example, headliners, door panels, instrument panels, dashboards, inserts, and the like, has long been known. Laminate panels have been made in a variety of types and ways. Interior trim panels commonly include a core layer or substrate of a polymeric material such as, for example, polyurethane, or polypropylene. One or more additional layers, including an outer layer, are typically attached to the substrate with an adhesive or other bonding method. The outer layer may be fabric, leather, or polymeric (e.g., polyester). The use of molded panels, whether a single material (e.g., polypropylene) or a composite material (e.g., fiberglass reinforced polyurethane foam), in automobile trim panels is also known.

Conventional laminate trim panels are complicated and expensive to produce because the manufacturing process involves multiple steps and components such as, for example, applying adhesives, placing layers, and heating components. Many of the materials commonly used in trim panels are non-degradable and cannot be recycled together and/or are difficult at best to separate. The use of various chemical adhesives also makes it more difficult and/or expensive to break down the trim panel into components for recycling. These trim panels also generally cannot be safely burned as they include non-combustible materials and/or produce noxious or toxic gases when combusted.

Environmental and economic concerns have led consumers to seek more environmentally friendly materials. For example, the use of lighter materials in vehicles reduces vehicle weight and increase fuel efficiency. Moreover, many conventional interior trim panels are made of polymeric materials that are petroleum derived (e.g., polyurethane, polypropylene). The volatility of oil prices and the unreliability of many sources of petroleum make reliance on petroleum-based products undesirable. Also, the inability to recycle trim panel materials that will eventually have to be discarded contributes to over-burdening of landfills. Consumers also increasingly desire products that are easy to recycle. Consumers also are increasingly concerned regarding chemical emissions from petroleum based products in new vehicles. Thus, there is considerable demand for more environmentally friendly or “green” products that meet the performance characteristics of existing products. In addition, consumers also seek environmentally-friendly products that are stylish and can be color coordinated as desired, and easily recycled.

Natural fibers have been used in various automobile trim panels, typically as substrates and supporting members. However, these types of fibers have not found extensive in trim panel surfaces visible to the occupant of a vehicle commonly referred to as class A surfaces, because they typically have poor wear characteristics and other drawbacks. Natural fiber sheets and products are generally more prone to become frayed or scratched from ordinary use. They are also more prone to becoming stained, as the fiber mesh will absorb contaminants and other stain-causing substances, making them difficult or impossible to clean. Therefore, currently any natural tendency of natural fibers to wick and absorb liquids also leads to unsightly swelling or expansion of the natural fiber sheet and at times significant deformations in the product. More problematic is that many of these natural fiber pieces or panels tend to also absorb cleaning liquids, further complicating attempts to clean them. Many natural fibers are also susceptible to damage or negative aesthetic effects (e.g., darkening) from ultraviolet (UV) light and other environmental factors, such as heat. Due to the many above characteristics, providing a long-lasting and pleasing tint or coloring is difficult to add using many existing methods without negatively affecting the end product.

### SUMMARY

This invention relates to natural fiber products and the methods of manufacturing natural fiber panels that are less prone to the shortcomings of prior natural fiber panels. This invention more specifically relates to a trim panel comprising a fiber layer and a transparent protective layer and/or coating formed from a protective material wherein the fiber layer further comprises plant or other natural, non-petroleum based fibers. The invention is further directed to a trim panel including a tinting material providing a tinted or colored effect to the fiber layer.

This invention also relates to a method for forming a trim panel comprising providing a sheet containing natural fibers including in some instances plant fibers, applying a protective material to a surface of the fiber sheet to create a protective layer, and compression molding the fiber sheet to form a trim panel. Of course, in some instances, the natural fiber base layer may be shaped before applying the protective material. Some exemplary methods also include the steps of providing a tinting material to provide perceived color or tint to the trim panel.

These and other features and advantages of various embodiments of systems and methods according to this invention are described in, or are apparent from, the following detailed description of various exemplary embodiments of various devices, structures, and/or methods according to this invention.

### BRIEF DESCRIPTION OF THE DRAWINGS

Various exemplary embodiments of the systems and methods according to the present disclosure will be described in detail, with reference to the following figures, wherein:

FIG. 1 is a fragmentary perspective view of an automobile interior with various exemplary embodiments of trim panels formed from natural fibers according to this invention;

FIG. 2 is a perspective view of an exemplary embodiment of a door panel according to this invention;

FIG. 3 illustrates a first exemplary process for forming a trim panel from a sheet of natural fiber material according to this invention;

FIG. 4 illustrates a second exemplary process for forming a trim panel from a sheet of natural fiber material according to this invention;

FIG. 5 illustrates a third exemplary process for forming a trim panel from a sheet of natural fiber material according this invention;

FIG. 6 is a flow chart that shows the process of the present invention;

FIG. 7 is an exploded perspective view of exemplary layers forming an exemplary trim panel; and

FIG. 8 is an exploded perspective view of exemplary layers forming an exemplary trim panel.

### DETAILED DESCRIPTION

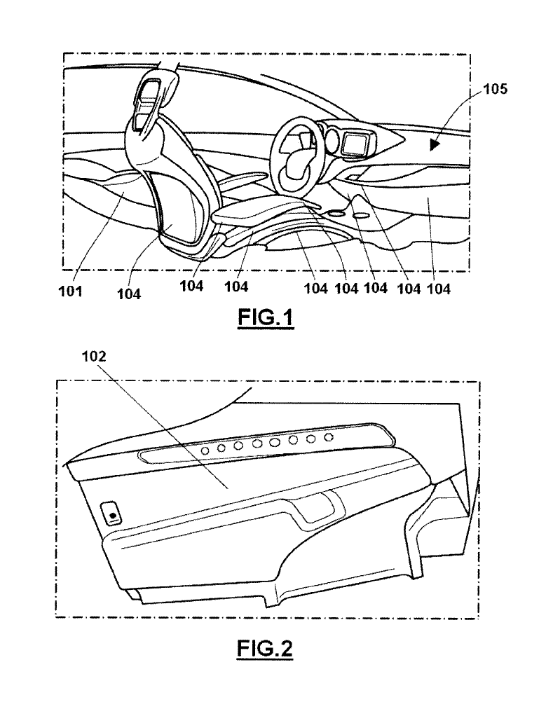

This invention relates to trim panels 100, exemplarily illustrated in FIGS. 1 and 2 as door panels 101, 102, a dashboard 105 and other vehicle panels 104, formed generally from a natural fiber base layer 110 and including a transparent protective material, such as a protective layer 111 and/or coating covering the natural fiber sheet. The protective material 111 is typically applied to the class A surface, as illustrated in FIG. 8. The protective material 111 is wear and/or scratch resistant, UV resistant (e.g., at least partially opaque to UV light), and impermeable or resistant to liquids commonly occurring inside a vehicle compartments, such as water, soda pop, coffee and tea. The protective material 111 also prevents the visible side or class A surface of the natural fiber sheet 110 from becoming frayed with wear.

FIG. 1 shows an exemplary automobile interior where various trim panels 101, 104, and 105 are made from natural fiber sheets of the present invention and without coverstock material. As used in this application, “coverstock material” refers to typical coverings found in vehicles, such as cloth materials that covered prior art fiber panels. As used in this application, “coverstock material” does not include the protective material of the present invention or if present any tinted or colored layers.

The natural fiber trim panels 100 may form any desired panel in any desired shape, size or configuration, such as the trim panels illustrated in FIG. 1, including a first exemplary door panel 101 and an exemplary dashboard 105. It should be appreciated that the dashboard 105 shown in FIG. 1 can include various styles, shapes and configurations and FIG. 1 only illustrates one exemplary embodiment. It should be appreciated that the exemplary wing armrest illustrated in FIG. 1, like the trim panel 101 and the other vehicle panels 104 can be formed using the natural-fiber panel 110 described above. FIG. 2 also shows a second exemplary door panel 102 that is made from natural fibers without any coverstock material. The present invention may be formed into numerous products of varying styles, configurations, and designs in vehicles as well as other items, such as furniture where it is desirable to use environmentally-friendly materials with the natural fibers forming a visible wear-resistant outer surface.

The fiber sheet 110 is predominantly formed from natural fibers from sources such as wood fibers, lignin fibers or other cellulose fibers, for example, wood, kenaf, hemp, jute, flax, ramie, roselle, rattan, soy bean, okra, banana fiber, bamboo, coconut, coir, cotton, curaua, abaca, pine, pineapple, raffia, and/or sisal. In some limited embodiments, the fiber sheet 110 may also include synthetic fibers such as, for example, acrylic, aramid, twaron, kevlar, technora, nomex, carbon, microfiber, nylon, olefin, polyester, polyethylene, rayon, spandex, tencel, vinalon, zylon, and/or polypropylene, however the majority of the material is still natural fiber material. In the preferred embodiment, the fiber sheet contains less than 50% synthetic fibers and more preferably less than 30% synthetic fibers. Many trim panels 100 may use fiber sheets 110 formed from approximately 100% natural fibers. The fiber sheet 110 may be formed by any known process.

In the various exemplary embodiments, the protective material 111 is transparent to visible light, highly resistant to scratching, UV resistant (e.g., at least partially opaque to UV light), and/or resists penetration by common liquids (e.g., is hydrophobic). The protective layer 111 is generally a sheet 112 or film of transparent material such as, for example, urethane, acrylic, thermoplastic polyurethane (TPU), thermoplastic olefin (TPO), polyester, and/or polycaprolactone, but also may be a spray material 115. The protective material 111 is typically applied as a sheet or film having a thickness of about 0.025 to 0.15 mm and when applied has a desirable thickness of about 0.020 to 0.080 mm thick. Of course, the applied thickness may widely vary given the natural characteristics of the fiber sheet. For most materials the protective material is applied generally about 0.030 to 0.070 mm in thickness, but other thicknesses may be used as appropriate for a given protective material 111. It has been found that approximately 0.040 to 0.06 mm thickness generally provides sufficient protection and allows for easy, cost effective, and efficient manufacturing. The thickness of the protective layer 111 may vary depending on the type of material forming the protective material 111. For example, protective layer of 0.1 mm thickness has been found to work well when polycaprolactone-based aliphatic thermoplastic polyurethane forms the protective layer 111 and 70% pinewood fibers and 20% PET/polypropylene and 10% acrylic binder forms the fiber sheet 110. In various exemplary embodiments, the protective material 111 or 112 is about 0.002 to about 0.012 in. in thickness, but other thicknesses may be used as appropriate for a given material.

Materials that have been found to work well as protective materials to fiber layers formed of natural fibers are polyols, such as polyether, polyester, polycaprolactone, polycarbonate or any organic oil based polyol (i.e., soy, corn, and castor). In particular, materials that work well as protective materials to natural fibers have generally a TMA range of 60° C. to 170° C. The range is generally selected to have a minimum TMA of 60° to prevent a tacky surface on the finished part of the vehicle and a maximum of 170° C. to reduce the energy required to apply the protective coating, as well as prevent destroying any thermoset reaction binding the fiber mat together that forms the fiber sheet. It has also been found that protective materials with a TMA range of 80° C. to 150° C. exceptionally bond or couple with the fiber sheet 110, and do not require additional hot melts or adhesives to bond to the fiber mat or sheet 110. A narrowed range of 100° C. to 130° C. also works well. If the max TMA of a protective material is too low, instead of providing a protective layer, the protective material would soak into the natural fiber sheet, and in some instances, even into the fibers themselves and (1) would leave little to no protective layer, which would not create a sufficient stain and water barrier and (2) may deform or discolor the fiber sheet 111. If the max TMA of the protective material is too high, the film would not allow sufficient gas and water molecules to escape during the molding process, which could cause pitting or blisters thereby creating an unappealing look and feel, or would require extra steps of mechanically, such as by laser chemically or other means pitting the protective material 111 to allow such gas and water to escape during the process step of adhering the protective material 111 to the fiber sheet. One common problem is blistering of the protective layer 111 when the fiber sheet 110 is heated during application and/or shaping in a heating compression mold, mainly due to moisture in the natural fibers being vaporized.

The trim panel 100 may be formed through a variety of exemplary methods from a natural fiber sheet 110. The natural fiber sheet 110 may be shaped to a final shape in a compression mold 120, which is closed over the fiber sheet 110 to compress it and form it into the shape of a desired trim panel, before or after the protective material is applied. Once the fiber sheet 110 is shaped, it is removed from the compression mold 120 and, if necessary, any subsequent steps such as, for example, trimming offal, which may be performed in a secondary process or by in-tool trimming, are performed. The protective material 111 may be applied, generally as a spray or a film. In various exemplary embodiments, the natural fiber sheet 110 and/or the mold 120 may be heated.

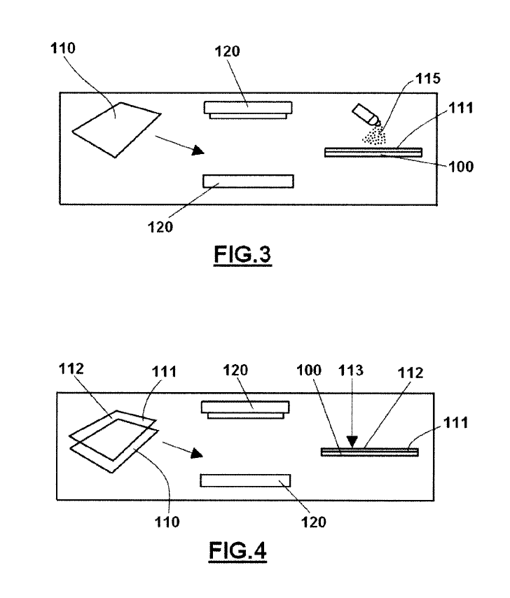

While it is generally preferable to first apply the protective material 111 to the fiber sheet 110, FIG. 3 illustrates an exemplary method for forming a trim panel 100 from a fiber sheet 110 where the protective material 111 is applied after molding to the final shape of the trim panel 100. As illustrated in FIG. 3, the fiber sheet 110 is shaped by compression molding a natural fiber sheet 110 in a mold 120. As further illustrated in FIG. 3, after shaping the fiber sheet 110, the show surface 113 of the trim panel 100 is coated with a transparent protective material 111. The protective material 111 is illustrated as a sprayed on material 115. The protective material 111 may be applied with heat and pressure onto the shaped fiber sheet 110, or as specifically illustrated in FIG. 3, the protective material 111 is sprayed by any acceptable method onto the fiber sheet 110. Of course, the protective material 111 may be applied to the shaped fiber sheet 110 by any appropriate, known, or later-developed technique, process, or method.

It is believed that applying the protective material 111 to the fiber sheet 110 prior to compression molding, allows for better adhesion, aesthetic appeal, faster processing times and/or more cost effective manufacturing. In particular, the heat and/or pressure during compression molding process to shape the fiber sheet causes the protective material to be better adhered to the fiber sheet 110.

Although not illustrated, the process in FIG. 3 could be changed such that the protective material 111 may be sprayed on before the step of molding. Of course, before entering the mold 120, a mold release processing aid or slip agent 121 may be applied.

FIG. 4 illustrates forming a trim panel 100 from a fiber sheet 110. The eventual show surface 113 of the fiber sheet 110 is coated with a protective material 111. The fiber sheet 110 and a protective material 111, shown as a protective sheet 112, are placed in a compression mold 120, which is closed over the fiber sheet 110 and protective material sheet 112 to compress them and form them into the shape of a desired trim panel 100. In various exemplary embodiments, the protective material sheet 112 is a thin film. In other exemplary embodiments, the protective material sheet 112 may be applied to the fiber sheet 110 by any appropriate, known, or later-developed technique, process, or method. Of course, the protective material 111 may be applied to the fiber sheet 110 after compression molding and obtain similar adherence to the fiber sheet 110 by an exemplary process of heating and vacuum pressing the protective material sheet 112 onto the fiber sheet 110. Although the figures illustrate only a sheet of protective material, this sheet is expected to be supplied from a roll of protective material. Although not illustrated, a processing aid may be applied in FIG. 4 to the combined fiber sheet 110 and protective material 111.

After the fiber sheet 110 is formed, the protective material 111 is applied. The protective material 111 is formed from the materials described above is configured to be applied without the need for additional processing of the fiber sheet, such as perforation of the fiber sheet 110 by laser or other means. To ensure proper application of the protective material, a slip agent or mold release, forming less than two percent (2%) by weight of the protective material may be used. The slip agent 121 is generally formed from unsaturated fatty acid amides, most commonly oleamide, and erucamide. The slip agent is included in or applied to one side of the protective material, particularly when it is used from rolls in a manufacturing process. The slip material specifically acts to prevent the film form sticking to itself (blocking) during processing. The slip material, if present, is included in the protective material preferably in a range of 1000 ppm to 200 ppm by weight of the protective material, but is not required and the protective material 111 may be applied to the fiber sheet 110 without inclusion of the slip material.

The protective layer 111 is preferably applied with heat and pressure, and the TMA of the protective material is configured to be applied without hot melt or adhesive, such that only the protective material is applied to the fiber sheet 110. Instead, the protective material melts and conforms itself to the underlying fiber sheet 110 through applied heat and pressure without the need for additional adhesives. The heat and pressure may be applied through any process that sufficiently melts the protective material and ensures bonding or adhesion of the protective material to the fiber sheet. For example, a heated platen that applies pressure may be used. For many production embodiments a heated roller may be used, or multiple methods of applying heat and pressure may be combined. Depending on the underlying fiber material, the protective material 111 may actually embed itself into the fiber sheet 110 and for some fiber materials, such as wood fibers, the protective material 111 may be partially absorbed by fibers, increasing the strength of the bond between the fibers and the protective material 111, without the use of hot melts or other adhesives. However, for many protective materials 111, the protective material is not fully embedded until the molding process, if the protective material 111 is applied before the molding process to shape the fiber sheet 110.

If the fiber sheet 110 is shaped after the protective material 111 is applied, then the fiber sheet 110 is then passed to the molding or forming stage of the manufacturing operation after the application step. To capture the latent heat from the step of applying the protective material, the molding or forming step may be and is preferably performed immediately after the application step. A spray may be applied to the mold used to form the final shape to prevent sticking of the protective material to the mold, as is well known in the art. As described above, when the protective material 111 is applied before the shaping of the fiber sheet 111, the molding process embeds or further embeds the protective material 111 into the fiber sheet 110. The heat and pressure from the mold embeds the protective layer into the fiber sheet 110. The heat in the molding process may be adjusted depending on the material used as the protective material, and is generally in a range near the melting point of the protective material to allow the protective material to, in a controlled fashion, embed into the fiber sheet, while also maximizing permeability of the protective material during the process. The high temperature of the mold must be limited to prevent the protective material from substantially soaking into the natural fibers, such that very little protective material is left to provide the intended function. The TMA ranges listed above, in particular 60-170° C., preferably 80-150° C. also work well during the molding process, as well as the narrowed range of 100-130° C.

The mold process is performed with heat and pressure and the heat is such that it is sufficient to sufficiently soften or melt the protective material to allow easy stretching of the material, further embedding of the protective material into the underlying fiber sheet, and further making the protective layer 111 permeable to gasses to allow gases or water vapor to pass through the film, and smooth the protective layer to create a final smooth stain-proof surface.

In the various exemplary embodiments, the molding procedure requires application of heat to the trim panel materials. The materials may be heated prior to entering the mold and/or heated in the mold (e.g., using a heated mold tool). The amount of heat applied and the length of that exposure may vary depending on the choice of materials used to form the trim panel. For example, the trim panel materials may be placed in a compression mold at about 150-220 degrees Celsius (mold temperature) for about one minute.

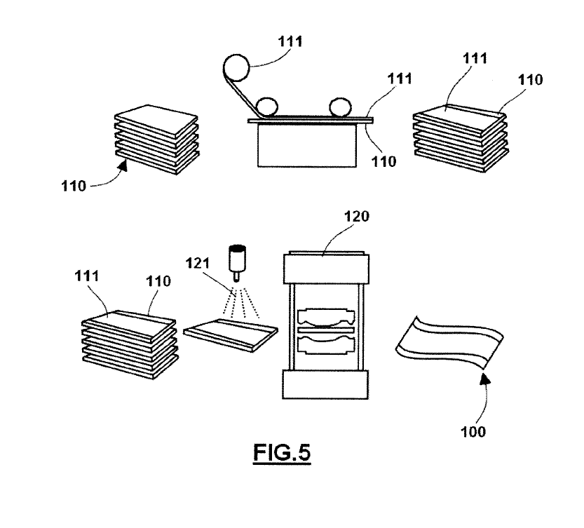

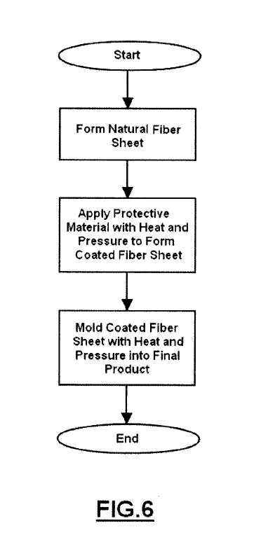

FIG. 5 provides a detailed sketch of an exemplary process. As illustrated in FIG. 5, first a sheet of natural fibers is formed. Then the protective material 111 is laminated to the natural fiber sheet 110. By laminating a sheet of protective material 111 to the fiber sheet 110 before shaping allows quick processing times and typically a more efficient manufacturing process. The combined fiber sheet 110 and protective material 111 is set aside for shaping. Although not illustrated in some embodiments, it may be desirable to apply the protective material 111 to surfaces of the fiber sheet 110 other than the class A surface, such as to seal the sheet from the effects of moisture, particularly when moisture sensitive natural fibers are sued. If desired, a mold release agent or slip aid 121 is then applied. The sheet is placed into the mold 120 preferably into a heated mold 120. The mold process is performed and a variety of factor may depend on the type of materials used, such as mold press times and mold temperatures. The trim panel 100 then exits the mold 120 and any secondary processing steps, such as trimming may be performed.

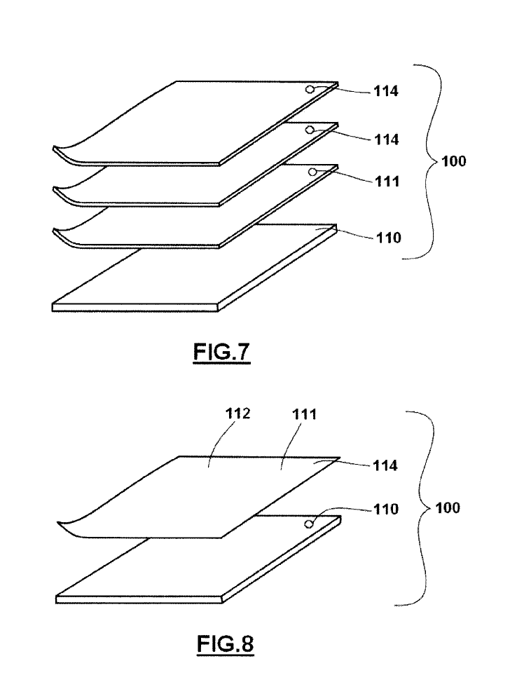

As illustrated in FIG. 7, the trim panel 100 may be formed with a fiber sheet 110 to which is applied an opaque, non-transparent protective material 111. The opaque non-transparent protective material 111 provides a background color or base color. To this may be applied various tinted or clear layers, such as the tinted sheets of film 114 illustrated in FIG. 7. While it is expected that one tinted sheet will primarily be used when a tinted layer 114 is desired, as illustrated in FIG. 7, additional tinting layers 114 may be used to create various desired colored or tinting effects.

The tinting may be combined with the protective material 111, as illustrated in FIG. 8, to create colors or tints, which may be opaque or transparent to show the material fibers of the fiber sheet 110. In addition, although not illustrated, the tint may be applied as a spray directly to the natural fibers with the protective layer 111 then applied over it. In some embodiments, this protective material 111 may be clear, with a colored or tinted fiber sheet 110. Of course, the protective layer 111 may be tinted also in addition to the fiber sheet 110. In addition, a glazing tint may be applied to the protective layer 111 with another clear layer applied over it (not illustrated). For ease of manufacturing, the protective material is preferable tinted or colored in the base resin of the protective material 111. This minimizes the number of processing steps needed during the manufacturing process.

The tint may be applied to the natural wood fibers or added to the protective material 111 or any other applied film through any known process. If additional tinted layers 114 are applied to the protective material 111, one method of applying may be by vacuum wrapping the tinted layer 114 over the fiber sheet 110 and protective material 111.

It should be noted that references to relative positions (e.g., “top” and “bottom”) in this description are merely used to identify various elements as are oriented in the figures. It should be recognized that the orientation of particular components may vary greatly depending on the application in which they are used.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

It is also important to note that the construction and arrangement of the trim panel, as shown in the various exemplary embodiments, is illustrative only. While the trim panel, according to this invention, has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the trim panel, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

1. A trim panel comprising:
a base layer formed from substantially natural fibers;
a protective material directly applied to said base layer without the use of an intervening hot melt adhesive and wherein said protective material has a TMA range of 60° C. to 170° C.

2. The trim panel of claim 1 wherein said natural fibers are selected from the group consisting of wood fibers, lignin fibers or other cellulose fibers, for example, wood, kenaf, hemp, jute, flax, ramie, roselle, rattan, soy bean, okra, banana fiber, bamboo, coconut, coir, cotton, curaua, abaca, pine, pineapple, raffia, and/or sisal.

3. The trim panel of claim 1 wherein said protective material is formed from a material selected from the group consisting of polyols, such as polyether, polyester, polycaprolactone, polycarbonate or any organic oil based polyol (i.e., soy, corn and castor).

4. The trim panel of claim 1 further including a tinting material.

5. The trim panel of claim 1 wherein said protective material has a thickness of approximately 0.02 mm to 0.15 mm.

6. The trim panel of claim 1 wherein said protective material is at least partially embedded in said base layer.

7. The trim panel of claim 1 wherein said natural fibers include openings and wherein said protective material is at least partially absorbed into said openings and said protective material is only applied to one side of said base layer.

8. The trim panel of claim 1 wherein said base layer includes up to 50% synthetic fibers by weight.

9. The trim panel of claim 1 wherein said protective material is permeable to gasses and water vapor between 60° C. to 170° C.

10. The trim panel of claim 1 wherein said protective material is substantially impervious to liquid water, and ultraviolet light.

11. The trim panel of claim 1 wherein said protective layer is not perforated.

12. The trim panel of claim 1 wherein said protective material includes a tinting agent and is substantially free from added perforations.

13. A trim panel comprising:
a base layer formed from substantially natural fibers;
a protective material directly applied to said base layer without the use of an intervening hot melt adhesive and wherein said protective material has a TMA range of 60° C. to 170° C.; and
a tinting material applied to at least one of said base layer and said protective material.

14. The trim panel of claim 13 wherein said natural fibers are selected from the group consisting of wood fibers, lignin fibers or other cellulose fibers, for example, wood, kenaf, hemp, jute, flax, ramie, roselle, rattan, soy bean, okra, banana fiber, bamboo, coconut, coir, cotton, curaua, abaca, pine, pineapple, raffia, and/or sisal.

15. The trim panel of claim 13 wherein said protective material is formed from a material selected from the group consisting of polyols, such as polyether, polyester, polycaprolactone, polycarbonate or any organic oil based polyol (i.e., soy, corn and castor).

16. The trim panel of claim 13 wherein said base layer includes recesses between said natural fibers and wherein said protective layer at least partially fills said recesses.

17. The trim panel of claim 16 wherein said tinting material is applied directly to said fibers.

18. The trim panel of claim 16 wherein said tinting material is located between said protective material and said natural fibers.

19. The trim panel of claim 16 wherein said protective material is located between said natural fibers and said tinting material.

20. The trim panel of claim 13 wherein said TMA range is between 80° C. to 150° C.

21. The trim panel of claim 13 wherein said base layer includes up to 50% synthetic fibers by weight.

22. The trim panel of claim 13 wherein said protective material is permeable to gasses and water vapor between 60° C. to 170° C.

23. The trim panel of claim 13 wherein said protective material is substantially impervious to liquid water, and ultraviolet light.

24. The trim panel of claim 13 wherein said protective layer is not perforated.

25. The trim panel of claim 13 wherein said protective material includes said tinting material.

26. A method of forming a trim panel comprising the steps of:
providing a base layer formed from substantially natural fibers;
providing a protective material that is substantially impervious to liquid water and ultraviolet light while being permeable to gasses and water vapors between 60° C. to 220° C.; and
applying said protective material to said base layer.

27. The method of claim 26 wherein said step of applying said protective material further includes the step of applying heat between 60° C. to 220° C.

28. The method of claim 26 wherein said step of applying said protective material further includes the step of compression molding said base layer and said applied protective material into a final shape.

29. The method of claim 28 wherein said step of applying said protective material is before a step of shaping said base layer and said applied protective material.

30. The method of claim 26 wherein said step of applying said protective material further includes the step of embedding said protective material into said natural fibers.

31. The method of claim 26 wherein said step of applying said protective material is after a step of shaping said base layer.

32. The method of claim 26 wherein said step of applying said protective material includes the step of applying heat at approximately 220° C.

33. The method of claim 26 wherein said step of applying said protective material includes the step of applying heat at approximately 170° C.

34. A trim panel comprising:
a base layer formed from substantially natural fibers;
an unperforated protective material directly applied to said base layer without the use of an intervening hot melt adhesive and wherein said protective layer is impervious to water and ultraviolet light at ambient temperatures and permeable to gasses and water vapor between 60° and 220° C.
